(19) United States
(12) Patent Application Publication
(10) Pub. No.: US 2003/0099423 A1
(43) Pub. Date: May 29, 2003

(54) Planar lightwave circuit having an integrated dispersion compensator using a fourier filter

(76) Inventors: Koorosh Aflatooni, Cupertino, CA (US); Anthony J. Ticknor, Cupertino, CA (US)

Correspondence Address: WAGNER, MURABITO & HAO LLP, Third Floor, Two North Market Street, San Jose, CA, 95113, US

(21) Appl. No.: 09/997,982

(22) Filed: Nov. 29, 2001

(51) Int. Cl. G02B 6/12; G02B 6/26; G02B 27/46

(52) U.S. Cl. 385/14; 385/27; 359/559

(57) ABSTRACT

An integrated dispersion compensator planar lightwave circuit (PLC). The PLC includes an input for receiving a fiber optic signal. The input couples the signal to a Fourier filter. The filter is configured to add a phase compensation to the signal to correct a chromatic dispersion of the signal. An output is coupled to transmit the dispersion compensated signal from the Fourier filter to other components on the PLC or to other external devices. The Fourier filter can be implemented using a tap delay filter. The tap delay filter can be implemented by using a plurality of delay lines for implementing the phase compensation for the signal. The delay lines can be implemented using Mach Zehnder couplers, wherein the Mach Zehnder couplers are configured to distribute power from signal between the delay lines and to recombine the power from the delay lines to generate the dispersion compensated signal. A plurality of thermal optic phase shifters can be coupled to the delay lines to generate the phase compensation.

### FIELD OF THE INVENTION

The present invention relates generally to the signal optimization of modern fiber-optic communications networks. More particularly, the present invention relates to a method and system for correcting chromatic dispersion using planar lightwave circuits.

### BACKGROUND OF THE INVENTION

Planar lightwave circuits comprise fundamental building blocks for the newly emerging, modern fiber-optic communications infrastructure. Planar lightwave circuits are innovative devices configured to transmit light in a manner analogous to the transmission of electrical currents in printed circuit boards and integrated circuit devices. Examples include arrayed waveguide grating devices, integrated wavelength multiplexers/demultiplexers, optical switches, optical modulators, wavelength-independent optical couplers, and the like.

Planar lightwave circuits (PLCs) generally involve the provisioning of a series of embedded optical waveguides upon a semiconductor substrate (e.g., silicon), with the optical waveguides fabricated from one or more silica glass layers, formed on an underlying semiconductor substrate. Fabrication techniques required for manufacturing PLCs using silica glass is a newly emerging field. Electronic integrated circuit type (e.g., CMOS) semiconductor manufacturing techniques have been extensively developed to aggressively address the increasing need for integration in, for example, the computer industry. This technology base is currently being used to make PLCs. By using manufacturing techniques closely related to those employed for silicon integrated circuits, a variety of optical circuit elements can be placed and interconnected on the surface of a silicon wafer or similar substrate. This technology has only recently emerged and is advancing rapidly with leverage from more mature tools of the semiconductor-processing industry.

PLCs are constructed with a number of waveguides precisely fabricated and laid out across a silicon wafer. A conventional optical waveguide comprises an un-doped silica bottom clad layer, with at least one waveguide core formed thereon, and a cladding layer covering the waveguide core, wherein a certain amount of at least one dopant is added to both the waveguide core and the cladding layer so that the refractive index of the waveguide core is higher than that of the cladding layer. Fabrication of conventional optical waveguides involves the formation of a silica layer as the bottom clad, usually grown by thermal oxidation upon a silicon semiconductor wafer. The core layer is a doped silica layer, which is deposited by either plasma-enhanced chemical vapor deposition (PECVD) or flame hydrolysis deposition (FHD). An annealing procedure then is applied to this core layer (heated above 1000C). The waveguide pattern is subsequently defined by photolithography on the core layer, and reactive ion etching (RIE) is used to remove the excess doped silica to form one or more waveguide cores. A top cladding layer is then formed through a subsequent deposition process. Finally, the wafer is cut into multiple PLC dies and the dies are packaged according to their particular applications.

Prior art FIG. 1 shows a cross-section view of a conventional planar optical waveguide. As depicted in FIG. 1, the planar optical waveguide includes a doped SiO₂ glass core 10 formed over a SiO₂ bottom cladding layer 12 which is on a silicon substrate 13. A SiO₂ top cladding layer 11 covers both the core 10 and the bottom cladding layer 12. As described above, the refractive index of the core 10 is higher than that of the cladding layers 11 and 12. Consequently, optical signals are confined axially within core 10 and propagate lengthwise through core 10. The SiO₂ glass core 10 is typically doped with Ge or P to increase its refractive index. In many types of PLC devices, a large number of cores (e.g., 40 or more) are used to implement complex fiber-optic functions, such as, for example, arrayed waveguide grating multichannel multiplexers and de-multiplexers.

Thus, PLCs comprise fundamental building blocks for the modern fiber-optic communications infrastructure. The PLCs provide the means for organizing and concentrating optical signals for transmission at one end of an optical fiber and the means for extracting and detecting optical signals received at the other end of the optical fiber.

There exists a problem however, with signal dispersion, or more specifically, chromatic dispersion, in the transmission of optical signals across long distances through fiber-optic cables (e.g., bundles of optical fibers). As is well known, chromatic dispersion is an important issue in high-speed fiber optic communication networks. As the bit rate of a transmission system increases, the susceptibility to chromatic dispersion increases. For example, in a fiber-optic transmission system functioning at 40 Gb per second per channel, the system can only tolerate a dispersion in order of 10 ps/nm.

Prior art FIG. 2 shows a diagram of a transmitted optical pulse on the left and the corresponding received optical pulse on the right, and prior art FIG. 3 shows a diagram of a fiber-optic transmitter 21 transmitting the optical pulse across a distance of fiber-optic cable to a fiber-optic receiver 22. As depicted in FIG. 1, the transmitted optical pulse undergoes chromatic dispersion, wherein the power of the optical pulse (on the vertical axis) is spread with respect to time (on the horizontal axis). This occurs as the transmitted optical pulse propagates through long distances of optical fiber, as shown in FIG. 2. The different frequency components of the transmitted pulse propagate through the optical fiber at different speeds. Thus, the relatively square profile of the transmitted pulse on the left becomes the dispersed profile of the received pulse on the right after propagation through some distance of optical fiber (e.g., 100 kilometers or more).

Prior art FIG. 4 shows consecutive pulses of a signal received at the receiver 22 with respect to the same pulses transmitted from the transmitter 21. The problem occurs in the receiver 22 when the receiver 22 tries to sample an incoming pulse train of a signal. As depicted in FIG. 3, dispersion causes the power of consecutive pulses to blend in with one another. This can cause difficulty when the receiver 22 tries to sample the pulses to determine their logic level. Instead of being distinct square profile pulses as transmitted from the transmitter 21, the pulses are dispersed and blended when received by the receiver 22, making them difficult to reliably sample.

As described above, as the bit rate of a transmission system increases, the susceptibility to chromatic dispersion increases. High transmission frequencies means less time between the pulses. For example, in a fiber-optic transmission system functioning at 40 Gb per second, the system can only tolerate a dispersion in the order of 10 ps/nm before the dispersion makes the reliable detection and sampling of individual pulses virtually impossible. Additionally, the dispersion characteristics of the modern fiber-optic communications network change as the network configuration changes (e.g., as new network nodes are added, new cables added, new channels are multiplexed, and the like). Thus, any attempt at compensating for dispersion must be able to account for such changing network conditions.

Prior art solutions for dynamically compensating for chromatic dispersion have involved the use of ring resonators (e.g., IIR type filters) and variable phase shifters. These solutions have a critical drawback in that the fabrication of ring resonators and variable phase shifters have a number of critical dimensions. The critical dimensions make such devices very difficult to reliably manufacture.

Thus what is required is a solution capable of balancing the dispersion introduced through various building blocks of a communications network. Additionally, since the characteristics of the communications network change as the network reconfigures, the required solution should have a dispersion compensation means capable of handling not only static network conditions, but also dynamic, changing network conditions. The required solution should be more easily manufactured than prior art solutions and should not require very tight critical dimension control. The present invention provides a novel solution to the above requirements.

### SUMMARY OF THE INVENTION

The present invention provides a solution capable of balancing the dispersion introduced through various building blocks of a communications network. The present invention provides dynamic dispersion compensation capable of handling not only static network conditions, but also changing network conditions. The present invention is more easily manufactured than prior art solutions and does not require very tight critical dimension control.

In one embodiment, the present invention is implemented as a planar lightwave circuit (PLC) having an integrated dispersion compensator fabricated therein. The PLC includes an input for receiving a fiber optic signal from, for example, a fiber-optic communications network. The input couples the signal to a Fourier filter built into the PLC. The filter is configured to add a phase compensation (e.g., a phase compensation profile) to the signal to correct a chromatic dispersion of the signal. An output is coupled to transmit the dispersion compensated signal from the Fourier filter to other components on the PLC, such as for example, an integrated arrayed waveguide grating, or to other external devices, such as, for example, an external optical receiver.

The Fourier filter can be implemented using a tap delay filter. The tap delay filter can be implemented by using a plurality of delay lines for implementing the phase compensation for the signal. The delay lines can be implemented using Mach Zehnder couplers, wherein the Mach Zehnder couplers are configured to distribute power from the incoming signal between the delay lines and to recombine the power from the delay lines to generate the dispersion compensated signal. A plurality of thermal optic phase shifters can be coupled to the delay lines to generate the phase compensation. The thermal optic phase shifters provide dynamic phase compensation to account for changes in network conditions. The Fourier filter can be manufactured using standard PLC manufacturing techniques and does not require excessively tight critical dimension control.

### BRIEF DESCRIPTION OF THE DRAWINGS

The present invention is illustrated by way of example and not by way of limitation, in the Figures of the accompanying drawings and in which like reference numerals refer to similar elements and in which:

Prior art FIG. 1 shows a cross-section view of a conventional planar optical waveguide fabricated using a silica glass substrate.

Prior art FIG. 2 shows a diagram of a transmitted optical pulse on the left and the received optical pulse on the right.

Prior art FIG. 3 shows a diagram of a fiber-optic transmitter transmitting an optical pulse train across a distance of fiber-optic cable to a fiber-optic receiver.

Prior art FIG. 4 shows consecutive pulses of a signal received at the receiver with respect to the same pulses transmitted from the transmitter.

FIG. 5 shows a fiber-optic communication system in accordance with one embodiment of the present invention.

FIG. 6 shows a diagram of two signal pulses received at the filter and the two signal pulses after filtering by the filter in accordance with one embodiment of the present invention.

FIG. 7 shows a tap delay filter in accordance with one embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to obscure aspects of the present invention unnecessarily.

Embodiments of the present invention are directed towards to an integrated dynamic dispersion compensating Fourier filter capable of balancing the dispersion introduced through various building blocks of a communications network. The present invention provides dynamic dispersion compensation capable of handling not only static network conditions, but also changing network conditions. The present invention is more easily manufactured than prior art solutions and does not require very tight critical dimension control. The present invention and its benefits are further described below.

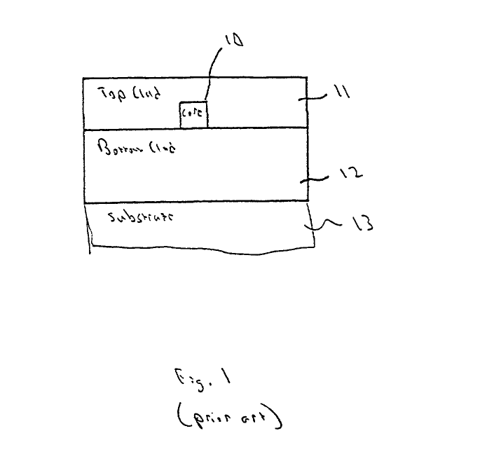

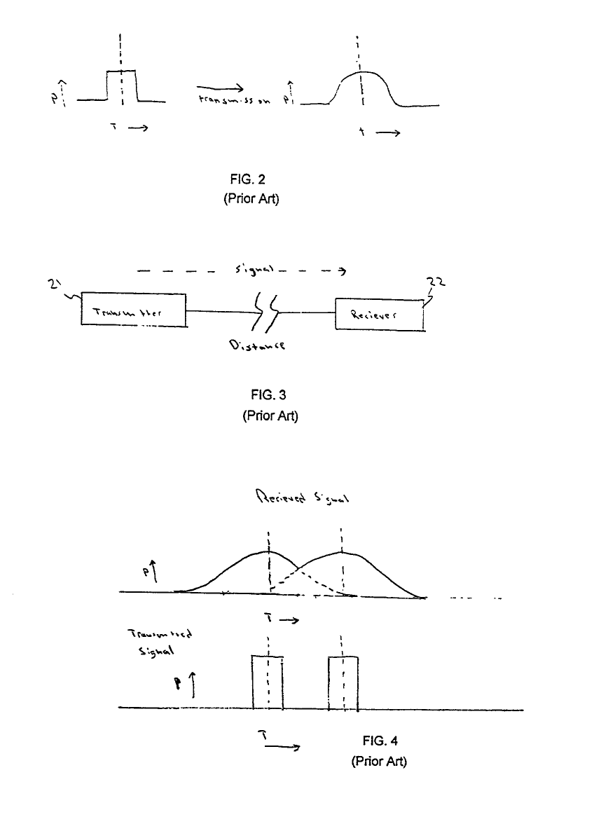

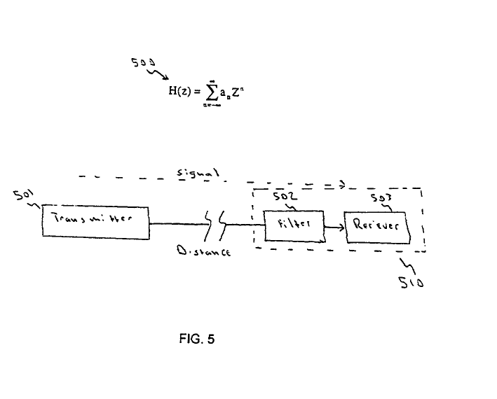

FIG. 5 shows a fiber-optic communication system in accordance with one embodiment of the present invention. As depicted in FIG. 5, a transmitter 501 is used to transmit optical signals across a distance to a filter 502 and a receiver 503. In this embodiment, the filter 501 and the receiver 503 are integrated into a single PLC device 510. The receiver 503 can be any of a number of PLC devices designed to receive the transmitted optical signals and process them. Examples include arrayed waveguide grating devices (AWGs), optical signal detectors, and the like.

The filter 501 functions by creating a phase compensation profile and adding the phase compensation profile to the incoming signal from transmitter 501. As is well-known, there exists chromatic dispersion problems in the transmission of optical signals across long distances through fiber-optic cables. Chromatic dispersion is an important issue in high-speed fiber optic communication networks. Such high-speed communication networks are often relied upon for transmitting terabytes of data across great distances. Data transfer capacity is in constant demand, and as new capacity is added to the network, that capacity is quickly used. One method of increasing data transfer capacity involves the increasing of the bit rate of the transmission. As the bit rate of a transmission system increases, the susceptibility to chromatic dispersion increases. For example, in a fiber-optic transmission system functioning at 40 Gb per second per channel, the system can only tolerate a dispersion on the order of 10 ps/nm.

Filter 501 functions as a Fourier filter that adds an excess phase (e.g., a phase compensation profile) to the incoming signal to compensate for the phase error introduced by dispersion. For example, an ideal dispersion compensator requires change of phase without affecting the magnitude of the signal (e.g., no excess loss added to the signal). This constitutes a transfer function h(f) that has the amplitude of unity at the absolute value of h(f) and the desired phase change required is expressed as φ=angle(h(f). The Fourier transform of this function is the required transfer function in z domain H(z) that can be expanded in terms of its unit delays with complex coefficients, shown as equation 500 in FIG. 5.

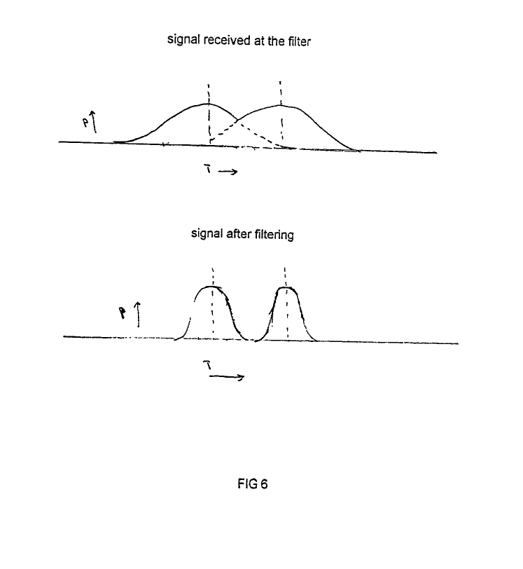

FIG. 6 shows φ in diagram of two signal pulses received at the filter 501 and the two signal pulses after filtering by filter 501. The upper trace shows the two pulses having been chromatically dispersed such that their energy (on the vertical axis) overlaps one another with respect to time (on the horizontal axis). Such pulses can be difficult or impossible to reliably detect (e.g., using an optical detector). The lower trace shows the two pulses after filtering and dispersion compensating within filter 501. As described above, filter 501 compensates for the chromatic dispersion, thereby providing more distinct separation between the two pulses, as shown.

In accordance with the present invention, the filter 501 functions by ensuring chromatic dispersion remains within specified limits, even as bit rates of the transmission system increase or as transmission conditions within the network change (e.g., as new nodes are added or removed, new lengths of fiber-optic cable are added, etc.). Hence, since the transmission and dispersion characteristics of the network change as the network reconfigures, filter 501 performs the important function of providing a compensation means not only for static transmission and dispersion conditions but also dynamic transmission and dispersion conditions.

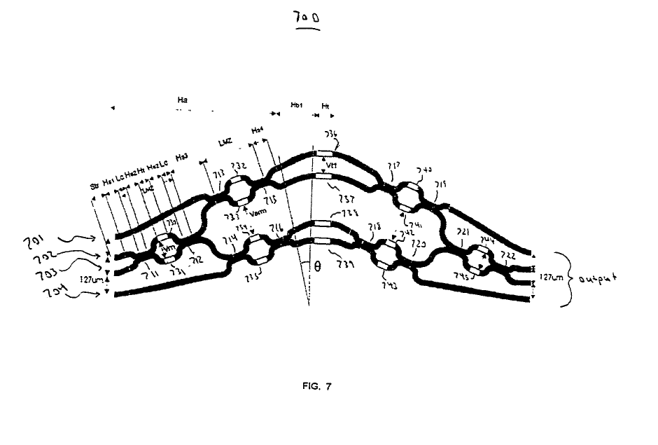

FIG. 7 shows a tap delay filter 700 in accordance with one embodiment of the present invention. Tap delay filter 700 is used to implement the Fourier filter function of the present invention. As depicted in FIG. 7, filter 700 incorporates 4 delay lines 701-704. Mach Zehnder couplers 711-722 are shown. Thermal optic phase shifters 721-745 are shown.

As described above, the Fourier transform of the phase compensation transfer function in z domain H(z) that can be expanded in terms of its unit delays with complex coefficients, shown as equation 500 in FIG. 5. The unit delays can be implemented using delay taps. Referring still to equation 500 of FIG. 5, aₙ is the coefficient corresponding to a given delay line. In this embodiment, this coefficient can have amplitude and phase, where the amplitude, for example, defines the amplitude redistribution between different delay lines and the phase, for example, defines the phase adjustment. This phase adjustment can be implemented using, for example, thermal optic phase shifters. In either case, the function of equation 500 can be realized using a tap delay filter, such as tap delay filter 700.

Referring to FIG. 7, the resolution of the filter 700 in compensating phase is determined by the number of tap delay lines that are used in the implementation. The free spectral range of the filter 700 is defined by the order of the path difference used between adjacent arms 701-704. The method used in filter 700 involves the use trees of Mach Zehnder couplers 711-716 to distribute power between different arms 701-704 and recombine them. An array of phase shifters 736-739 is used to introduce required phase shift for each arm.

Accordingly, the object of filter 700 is to allow incoming light to arms 701-704 with one wavelength to pass through unchanged, or with little attenuation, while light at other wavelengths is attenuated. Filter 700 shows an implementation of a tap delay filter. In tap delay filters, also referred to as Fourier filters, the filter function is achieved by breaking the light into beams that propagates different distances (e.g., through the adjacent arms 701-704). The light through each of these beams experience different phase change depending on the length of the arm and the particular wavelength. Hence, for a particular wavelength, a case can be realized wherein that light from all the arms interfere constructively and will pass through the filter. However, there exist other wavelengths wherein light from different arms will have opposite phases that result in destructive interference. The extreme case of attenuation occurs when light from different arms are completely out of phase with each other cause a complete attenuation.

Thus, at the inputs of arms 701-704, light has the same phase. By the end of the arms 701-704, the relationship (e.g., wavelength λ) between the light in the arms is such that light having a constructive phase relationship interfere constructively, while the light having a destructive phase relationship interferes destructively. By adjusting ΔL (e.g., by using phase shifters 736-739), the wavelengths that interfere constructively or destructively can be selected in order to tune the transmission spectrum of the filter.

Referring still to FIG. 7, in a manner similar to tuning the power spectrum, filter 700 can effect the phase relation between different wavelengths propagating through arms 701-704 as well. As described above, although the wavelengths in arms 701-704 start out with, for example, a π/4 phase difference, at the output of the filter, the wavelengths show a phase difference of 0. The output phase corresponds to the phase of the net beam emerging from different arms. If the incoming beam carries pulsed information, the resulting difference in phase will translate into different traveling time for pulses with different wavelengths. This traveling time difference is known as group delay. Chromatic dispersion is defined as the variation of group delay between different wavelengths.

The Fourier filter 700 compensates for chromatic dispersion by generating an “inverse” chromatic dispersion. When the light propagates through the filter 700 and is separated between different arms 701-704, the phase relation between light with different wavelengths changes. The emerging light depends on the net of all the lights from different arms 701-704 and how they add together. Therefore, the filter 700 can introduce a transmission spectral and also dispersion to the incoming beams. Usually, in Fourier filters the transmission spectral and phase are inter-related, as one can imagine by controlling the amplitude of the light that goes through a particular delay line, one could subtract (add) more to the transmitted amplitude as well as phase.

The phase response of the Fourier filter 700 is exploited to dynamically compensate for dispersion resulted from other sources in an optical network. Since a Fourier filter is constructed from a number of arms with different delays (delays are geometrical series of a constant delay), the response of the filter can be shown mathematically as (for ease of presentation we showed the transfer function in Z-domain):

H(z)=ΣαₙZ⁻ⁿ

where n defines arm with a delay n times the initial delay, and αₙ is the complex amplitude of light that goes through that arm. Based on what we presented before, this can be separated into the amplitude transmission and phase as:

H=|H|e^{jφ}

where |H| is the amplitude response of the filter and φ is the phase response of the filter. It is desirable to have control over φ with minimum effect on |H|. In general, this is related to free spectral range (FSR) of the filter (e.g., the constant delay that delay arms are multiple of that). As the FSR is reduced (e.g., increase the delay between the arms), a smaller change yields a large change in phase, and consequently on group delay and dispersion. For example, filter 700 can generate a variable ±20 ps/nm dispersion and change the slope of an input dispersion completely. One application would be the use of filter 700 to cancel the dispersion introduced by network conditions to a 100 GHz DWDM channel.

Thus, embodiments of the present invention are directed towards to an integrated dynamic dispersion compensating Fourier filter capable of balancing the dispersion introduced through the various building blocks of a communications network. The present invention provides dynamic dispersion compensation capable of handling not only static network conditions, but also changing network conditions. The present invention is more easily manufactured than prior art solutions and does not require very tight critical dimension control.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the claims appended hereto and their equivalents.

What is claimed is:

1. An integrated dispersion compensator planar lightwave circuit, comprising:
an input for receiving a fiber optic signal;
a Fourier filter coupled to receive the signal, the filter configured to add a phase compensation to the signal to correct a chromatic dispersion of the signal; and
an output coupled to transmit the dispersion compensated signal from the Fourier filter.

2. The planar lightwave circuit of claim 1 wherein the Fourier filter is implemented using a tap delay filter.

3. The planar lightwave circuit of claim 2 wherein the tap delay filter includes a plurality of delay lines for implementing the phase compensation for the signal.

4. The planar lightwave circuit of claim 2 wherein the tap delay filter includes a plurality of delay lines for implementing the phase compensation for the signal and wherein the delay lines are implemented using Mach Zehnder couplers.

5. The planar lightwave circuit of claim 4 wherein the Mach Zehnder couplers are configured to distribute power from signal between the delay lines and to recombine the power from the delay lines to generate the dispersion compensated signal.

6. The planar lightwave circuit of claim 4 wherein a plurality of thermal optic phase shifters coupled to the delay lines are used to generate the phase compensation.

7. A planar lightwave circuit having an integrated dispersion compensator, comprising:
an input for receiving a fiber optic signal;
a tap delay filter coupled to receive the signal, the filter configured to add a phase compensation to the signal to correct a chromatic dispersion of the signal; and
an output coupled to transmit the dispersion compensated signal from the filter.

8. The planar lightwave circuit of claim 7 wherein the tap delay filter includes a plurality of thermal optic phase shifters for implementing the phase compensation.

9. The planar lightwave circuit of claim 7 wherein the tap delay filter includes a plurality of delay lines, each of the delay lines including at least one thermal optic phase shifter for implementing the phase compensation for the signal.

10. The planar lightwave circuit of claim 9 wherein a plurality of Mach Zehnder couplers are used to distribute power from the signal to the delay lines.

11. The planar lightwave circuit of claim 10 wherein the Mach Zehnder couplers are configured to distribute power from signal between the delay lines and to recombine the power from the delay lines to generate the dispersion compensated signal.

12. The planar lightwave circuit of claim 7 wherein the tap delay filter includes a number of delay lines, the number of delay lines determining a spectral range of the filter.

13. An arrayed waveguide grating planar lightwave circuit having an integrated dispersion compensator, comprising:
an input for receiving a fiber optic signal;
a Fourier filter coupled to receive the signal, the filter configured to add a phase compensation to the signal to correct a chromatic dispersion of the signal; and
an output coupled to transmit the dispersion compensated signal from the Fourier filter to an arrayed waveguide grating.

14. The planar lightwave circuit of claim 13 wherein the Fourier filter is implemented using a tap delay filter.

15. The planar lightwave circuit of claim 14 wherein the tap delay filter includes a plurality of delay lines for implementing the phase compensation for the signal.

16. The planar lightwave circuit of claim 14 wherein the tap delay filter includes a plurality of delay lines for implementing the phase compensation for the signal and wherein the delay lines are implemented using Mach Zehnder couplers.

17. The planar lightwave circuit of claim 16 wherein the Mach Zehnder couplers are configured to distribute power from signal between the delay lines and to recombine the power from the delay lines to generate the dispersion compensated signal.

18. The planar lightwave circuit of claim 16 wherein a plurality of thermal optic phase shifters coupled to the delay lines are used to generate the phase compensation.
